(19) United States
(12) Patent Application Publication
(10) Pub. No.: US 2018/0188630 A1
(43) Pub. Date: Jul. 5, 2018

(54) Liquid Crystal Lens, Display Apparatus and Driving Method Therefor

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Wenqing ZHAO, Beijing (CN); Xiaochuan CHEN, Beijing (CN); Qian WANG, Beijing (CN); Jian GAO, Beijing (CN); Ming YANG, Beijing (CN); Pengcheng LU, Beijing (CN); Rui XU, Beijing (CN); Lei WANG, Beijing (CN); Xiaochen NIU, Beijing (CN)

(21) Appl. No.: 15/526,071

(22) PCT Filed: May 23, 2016
(86) PCT No.: PCT/CN2016/082967

§ 371 Date: May 11, 2017

(30) Foreign Application Priority Data
Mar. 29, 2016 (CN) 201610187286.8

(51) Int. Cl. G02F 1/29; G02B 27/00

(52) U.S. Cl. CPC G02F 1/29; G02F 2201/121; G02B 27/0093

(57) ABSTRACT

The present disclosure provides a liquid crystal lens, a display apparatus and a driving method thereof. The liquid crystal lens comprises a liquid crystal layer and a plurality of driving electrodes, the liquid crystal layer corresponding to each driving electrode is configured to refract a light entered therein under driving of the driving electrode, and each driving electrode is loaded with a driving voltage separately. The display apparatus comprises: a flat display panel configured to perform displaying; the liquid crystal lens described above, which is provided at a light exiting surface side of the flat display panel, and is configured to refract a light emitted from different positions of the flat display panel to a single position.

### TECHNICAL FIELD

The present disclosure relates to a field of display technology, and particularly, to a liquid crystal lens, a display apparatus and a driving method therefor.

### BACKGROUND

As shown in FIG. 1, generally, luminous intensities in different directions from each position of a display panel are different from each other. For example, the luminous intensity in a front direction (in a direction perpendicular to a light exiting surface) is relatively large, and the luminous intensity in an oblique direction is relatively small. As shown in FIG. 2, with respect to a flat display panel 11, when a person 9 is at a center position in front of the flat display panel 11 to watch the flat display panel 11, the light emitted from positions in right and left portions of the flat display panel 11 actually enters eyes of the person obliquely, thus the person 9 may feel that the center of the flat display panel 11 is bright and the right and left portions of the flat display panel 11 are dark, resulting in a poor display effect of the flat display panel 11. In particular, as a size of the display panel increases, the problem said above becomes more and more serious.

As shown in FIG. 3, the light emitted from different positions of a curved display panel 12 converges at an appropriate center position in front of the curved display panel 12, thus when the person 9 is at the appropriate center position in front of the curved display panel 12 to watch the curved display panel 12, the person 9 can experience an improved display effect. However, the curved display panel 12 only can improve the display effect obtained by watching the curved display panel 12 at the appropriate center position in front of the curved display panel 12, and when the person 9 is at other positions to watch the curved display panel 12, the person 9 still cannot experience the improved display effect. Meanwhile, since the curved display panel 12 is of a curve structure, for a same size of an actual display surface, the curved display panel 12 must occupy a larger space than the flat display panel, and in addition, the curved display panel 12 has a high manufacturing cost, a high process difficulty and so on.

### SUMMARY

In view of problems that the curved display panel of prior art only can improve the display effect obtained by watching the curved display panel at the appropriate center position in front of the curved display panel, and the curved display panel of prior art occupies a large space and results in a high cost and a high process difficulty, an object of the present disclosure is to provide a liquid crystal lens, a display apparatus and a driving method therefor, which are easy to be manufactured, can provide a good display effect for every orientations, and can reduce the occupied space and the cost.

In order to achieve the object said above, in an embodiment of the present disclosure, there is provided a liquid crystal lens which comprises a liquid crystal layer and a plurality of driving electrodes, the liquid crystal layer corresponding to each driving electrode is configured to refract a light entered therein under driving of the driving electrode, each driving electrode is loaded with a driving voltage separately.

In an embodiment, the liquid crystal lens further comprises a driving integrated chip with a plurality of channels, and each driving electrode is connected to one channel of the driving integrated chip through a lead wire.

In another embodiment of the present disclosure, there is provided a display apparatus which comprises:

a flat display panel configured to perform displaying;

the liquid crystal lens described above, which is provided at a light exiting surface side of the flat display panel, and is configured to refract a light emitted from different positions of the flat display panel to a single position.

In an embodiment, the display apparatus further comprises: an eye tracking device configured to track positions of eyes, the liquid crystal lens is configured to refract a light emitted from different positions of the flat display plane to the positions of eyes.

In an embodiment, the liquid crystal layer under driving of the driving electrodes is equivalent to a plurality of strip micro prisms and/or strip micro lenses.

In an embodiment, the liquid crystal lens is configured to refract a light emitted from different positions of the flat display panel along a first direction parallel to a side of the light exiting surface of the flat display panel to the single position.

In an embodiment, the flat display panel has a first dimension in the first direction, a second dimension in a second direction perpendicular to the first direction, wherein, the first dimension is equal to or larger than the second dimension, and the second direction is in a plane where the light exiting surface of the flat display panel is located.

In an embodiment, the driving electrodes are electrode strips, and a lengthwise direction of each electrode strip is perpendicular to the first direction.

In an embodiment, the driving electrodes are electrode blocks, and the electrode blocks are arranged in an array.

In an embodiment, the liquid crystal lens is configured to refract a light emitted in a direction perpendicular to the light exiting surface from different positions of the flat display panel to the single position.

In still another embodiment of the present disclosure, there is provided a driving method of the display apparatus described above, and the driving method comprises steps of:

driving the flat display panel to perform displaying;

loading a driving voltage onto each driving electrode of the liquid crystal lens so that the liquid crystal layer of the liquid crystal lens refracts a light emitted from different positions of the flat display panel to a single position.

In an embodiment, the display apparatus further comprises an eye tracking device, and the driving method further comprises:

tracking positions of eyes by the eye tracking device before loading the driving voltages onto the driving electrodes of the liquid crystal lens,

the step of loading the driving voltages onto the driving electrodes of the liquid crystal lens so that the liquid crystal layer of the liquid crystal lens refracts the light emitted from different positions of the flat display panel to the single position comprises: loading the driving voltages onto the driving electrodes of the liquid crystal lens in accordance with the positions of eyes, so that the liquid crystal layer of the liquid crystal lens refracts the light emitted from different positions of the flat display panel to the positions of eyes.

The display apparatus of the present disclosure comprises the liquid crystal lens described above, and since the driving electrodes of the liquid crystal lens may be driven separately, the refraction effect of each position of the liquid crystal lens can be controlled separately, therefore, the liquid crystal lens can refract (converge) the light (i.e., light entered into different positions of the liquid crystal lens) emitted from different positions of the flat display panel to the single position, thereby a display effect being the same as that of a curved display panel is achieved, and moreover, in the present disclosure, the position that the light converges to is changeable, thus even when a person is at a different position, the light still can been converged to the person's eyes, an improved display effect still can been achieved, and since the display apparatus still employs the flat display panel, the occupied space thereof is small, the cost thereof is low, and it is easy to fabricate it.

### DESCRIPTION OF DRAWINGS

FIG. 1 shows a diagram of light exiting intensities in different directions from a position of a display panel of prior art;

FIG. 2 shows a diagram when a flat display panel of prior art performs displaying;

FIG. 3 shows a diagram when a curved display panel of prior art performs displaying;

FIG. 4 shows a structural diagram of a cross section of a liquid crystal lens in an embodiment of the present disclosure;

FIG. 5 shows a diagram when a display apparatus in an embodiment of the present disclosure performs displaying in a state;

FIG. 6 shows a diagram when a display apparatus in an embodiment of the present disclosure performs displaying in another state;

FIG. 7 shows a structural diagram of a cross section of a mode of equivalent strip micro prisms of a liquid crystal lens in an embodiment of the present disclosure;

FIG. 8 shows a structural diagram of a cross section of another mode of equivalent strip micro prisms of a liquid crystal lens in an embodiment of the present disclosure;

FIG. 9 shows a structural diagram of a cross section of a mode of equivalent strip micro lenses of a liquid crystal lens in an embodiment of the present disclosure;

FIG. 10 shows a distribution diagram of driving electrodes in a liquid crystal lens in an embodiment of the present disclosure;

FIG. 11 shows another distribution diagram of driving electrodes in a liquid crystal lens in an embodiment of the present disclosure;

FIG. 12 shows still another distribution diagram of driving electrodes in a liquid crystal lens in an embodiment of the present disclosure;

FIG. 13 shows yet another distribution diagram of driving electrodes in a liquid crystal lens in an embodiment of the present disclosure.

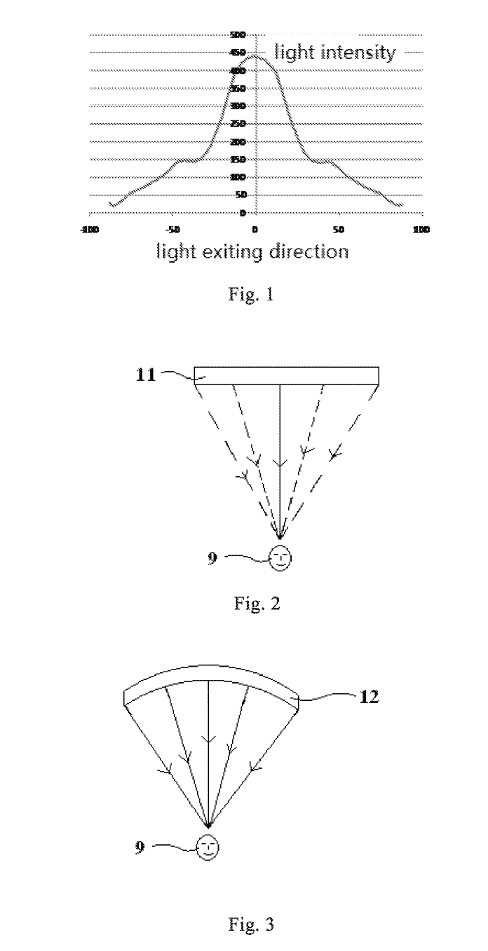

Reference Signs: 11, flat display panel; 12, curved display panel; 2, liquid crystal lens; 21, driving electrode; 22, liquid crystal layer; 23, common electrode; 29, substrate; 9, person.

### DESCRIPTION OF EMBODIMENTS

In order to make a person skilled in the art understand technical solutions of the present disclosure better, the present disclosure will be described in detail below in conjunction with accompanying drawings and specific implementations.

### First Embodiment

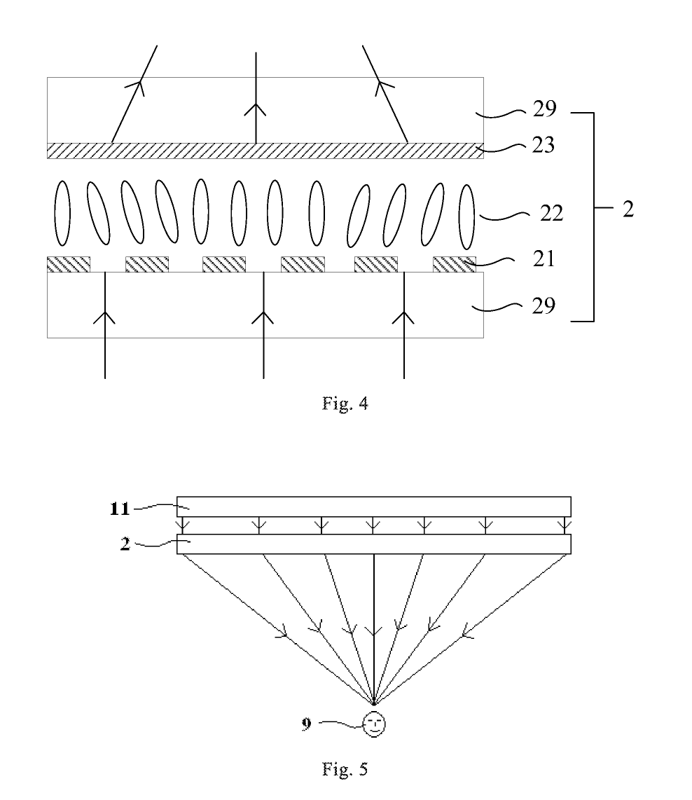

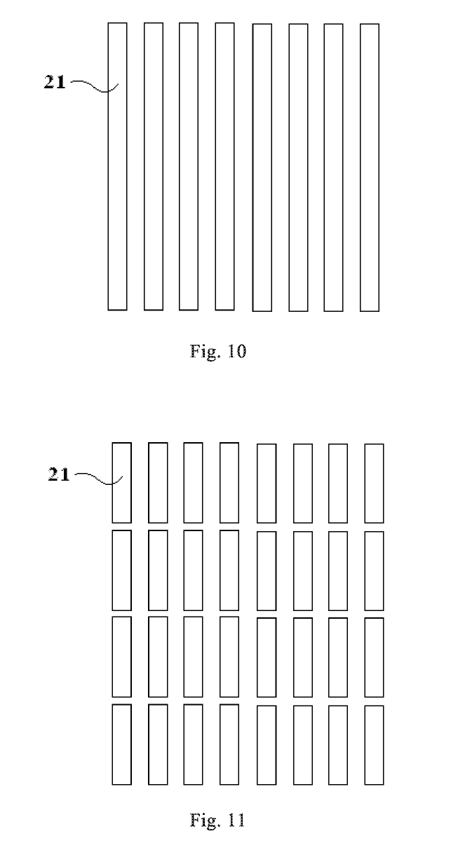

As shown in FIGS. 4-13, the embodiment provides a liquid crystal lens 2 comprising a liquid crystal layer 22 and a plurality of driving electrodes 21, each portion of the liquid crystal layer 22 corresponding to the driving electrodes 21 is configured to refract a light entered therein under driving of a corresponding driving electrode 21, each driving electrode 21 may be loaded with a driving voltage separately.

Although a liquid crystal lens, as an optical device, for changing a direction of light passing through it has been known in the prior art, only fixed driving voltages are loaded onto driving electrodes of the liquid crystal lens in the prior art, that is, the liquid crystal lens in the prior art only can produce a fixed refraction effect.

In contrast, as shown in FIG. 4, the liquid crystal lens 2 of the embodiment comprises two substrates 29, and the liquid crystal layer 22 is filled between the two substrates 29 (certainly, an alignment film, etc. may be provided, which will not be described in detail herein), wherein, the driving electrodes 21 are provided at a side of one substrate 29 proximal to the liquid crystal layer 22, a common electrode 23 is correspondingly provided at a side of the other substrate 29 proximal to the liquid crystal layer 22, and a fixed common voltage is applied to the common electrode 23, which will not be described in detail herein. By applying a driving voltage on each driving electrode 21, a voltage difference is formed between the driving electrode 21 and the common electrode 23, thus liquid crystal molecules in the liquid crystal layer 22 at a position corresponding to the driving electrode 21 are driven to twist by a certain angle. Due to birefringence of the liquid crystal molecules, the twisted liquid crystal molecules can play a role similar to prisms or lenses, and can change a propagation direction of light entered thereto. In the liquid crystal lens 2 of the embodiment, each driving electrode 21 may be controlled separately, that is, each driving electrode 21 is loaded with a different driving voltage separately at a different timing, thereby a refraction effect produced at each position of the liquid crystal lens 2 of the embodiment is controllable.

In an embodiment, the liquid crystal lens 2 further comprises a driving integrated chip, and each driving electrode 21 is connected to one channel of the driving integrated chip through a lead wire.

That is to say, the liquid crystal lens 2 of the embodiment may comprise a driving integrated chip (IC) with a plurality of channels, and each driving electrode 21 is connected to one channel (may also be referred to as a port) of the driving integrated chip through a lead wire. Obviously, each channel of the driving integrated chip can produce a required output signal separately, and the output signal is used as the driving voltage of the driving electrode 21.

Since the driving integrated chip produces output signals with a high precision and being changeable flexibly, the liquid crystal lens 2 may be controlled precisely. Moreover, there are many types of driving integrated chips, thus, with respect to different ranges, numbers, etc. of the driving voltages required by the driving electrodes 21, it is easy to select an appropriate driving integrated chip to control the driving electrodes 21 precisely, and technical solutions in the present disclosure are easy to be achieved.

Although the driving integrated chip with the plurality of channels are employed in the embodiment, and each driving electrode 21 is connected to one channel of the driving integrated chip, the present disclosure is not limited thereto, a plurality of driving integrated chips each of which has a single channel may be employed, and in this case, each driving electrode 21 is connected to one driving integrated chip, which will not be described in detail herein.

The embodiment also provides a display apparatus, comprising:

a flat display panel 11 configured to perform displaying;

the liquid crystal lens 2 of the embodiment, which is provided at a light exiting surface side of the flat display panel 11, and is configured to refract (converge) a light emitted from different positions of the flat display panel 11 along a first direction to a single position (for example, a position for watching by the person 9).

That is to say, the display apparatus of the embodiment comprises a conventional flat display panel 11 for performing displaying, the flat display panel 11 may be a liquid crystal display panel, an organic light emitting diode (OLED) display panel or the like, which will not be described in detail herein. The liquid crystal lens 2 described above is provided at a light exiting surface side of the flat display panel 11.

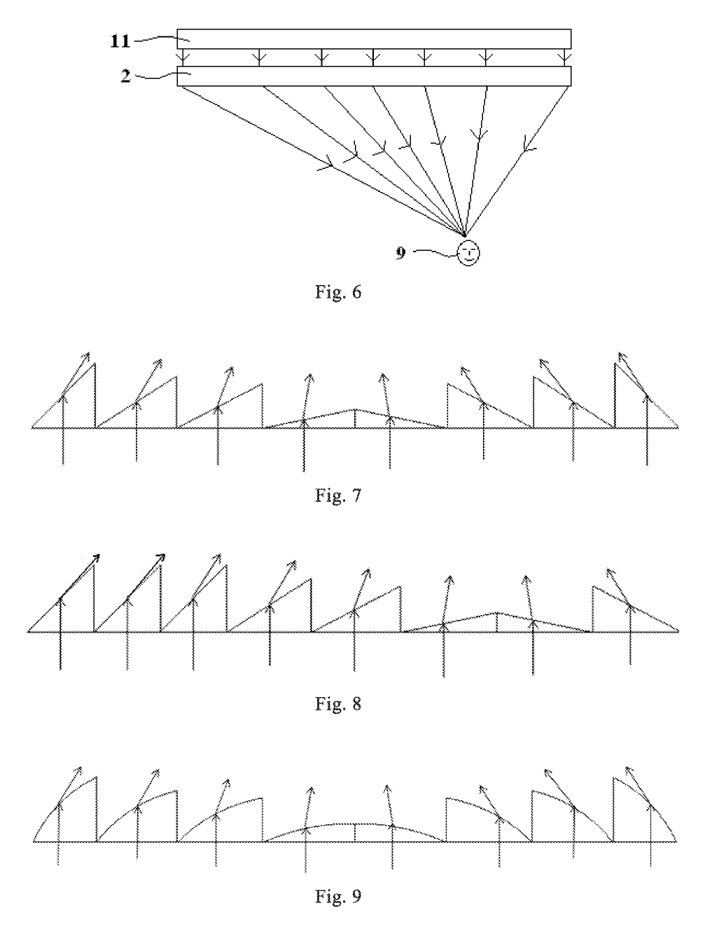

The display apparatus of the embodiment comprises the liquid crystal lens 2 described above, and since each driving electrode 21 of the liquid crystal lens 2 can be controlled separately, the refraction effect of each position of the liquid crystal lens 2 can be controlled separately. Therefore, as shown in FIGS. 5-6, the liquid crystal lens 2 can refract (converge) a light (e.g., the light emitted from different positions of the flat display panel 11 along a first direction to the liquid crystal lens 2 in a direction perpendicular to the light exiting surface of the flat display panel 11) emitted from different positions of the flat display panel 11 along a first direction to a single position, so as to achieve a display effect the same as that of a curved display panel. However, in the embodiment, the position that the light converges to is changeable, so that the person 9 can experience an improved display effect when the person 9 is at different positions. In addition, the display apparatus of the embodiment still employs the flat display panel 11, thus the occupied space thereof is small, the cost thereof is low, and it is easy to manufacture it.

As described above, each position of the flat display panel 11 actually emits light towards a plurality of directions, but only the intensity of the light emitted straight ahead is the largest. Thus, each position of the liquid crystal lens 2 of the embodiment can receive light emitted from a plurality of positions of the flat display panel 11, including the light emitted from a corresponding position of the flat display panel 11 in a direction perpendicular to the light exiting surface thereof and the light emitted from other positions obliquely. In an embodiment, the liquid crystal lens 2 may only converge the light emitted from every positions of the flat display panel 11 in the direction perpendicular to the light exiting surface thereof.

In an embodiment, the flat display panel 11 has a first dimension in the first direction, a second dimension in a second direction perpendicular to the first direction, and the first dimension is equal to or larger than the second dimension.

Generally, a display panel has different dimensions in a horizontal direction and a longitudinal direction respectively, and obviously, it will result in a more significant improved display effect while converging the light in a direction in which the display panel has a larger dimension, thus, in an embodiment, the dimension of the flat display panel 11 in the first direction may be larger than or equal to (preferably, larger than) the dimension thereof in the direction perpendicular to the first direction.

Generally, for example, the flat display panel 11 is of a rectangle shape, and has a relatively small width and a relatively large length, thus descriptions below are given by taking the first direction being the lengthwise direction of the flat display panel 11 as an example.

Certainly, although the embodiment is described by taking converging the light emitted from different positions of the flat display panel 11 along the lengthwise direction thereof as an example, the present disclosure is not limited thereto. By using different types of driving electrodes 21 and adjusting the corresponding driving voltages, the light emitted from different positions of the flat display panel 11 along the widthwise direction thereof may be converged to a single position, or, the light emitted from different positions of the flat display panel along both the lengthwise direction and the widthwise direction thereof may be converged to the single position (i.e., similar to an effect of spherical displaying), which will not be described in detail herein.

In an embodiment, the display apparatus of the embodiment further comprises: an eye tracking device configured to track positions of eyes, the liquid crystal lens 2 is configured to refract (converge) a light emitted from different positions of the flat display plane 11 along the lengthwise direction thereof to the positions of eyes.

That is to say, an eye tracking device (e.g., a camera with a function of tracking positions of eyes) may be provided in the display apparatus (e.g., on the flat display panel 11) to determine specific positions of eyes in real time, and the driving voltages loaded onto the driving electrodes 21 are correspondingly controlled, so as to ensure the liquid crystal lens 2 always (even when the person 9 is moving) converges the light emitted from different positions of the flat display plane 11 to the positions of eyes, and a good display effect can be achieved.

In an embodiment, the liquid crystal layer 2 of the embodiment under driving of the driving electrodes 21 is equivalent to a plurality of strip micro prisms and/or strip micro lenses, for example, the strip micro prisms and/or strip micro lenses can only converge the light emitted from different positions of the flat display panel 11 along the lengthwise direction thereof.

That is to say, the driving voltages loaded onto the driving electrodes 21 may be controlled so that the liquid crystal layer 22 has a refraction effect that is the same as that of the plurality of strip micro prisms and/or strip micro lenses as shown in FIGS. 7-9. Certainly, as described above, although the embodiment is described by taking converging the light emitted from different positions of the flat display panel 11 along the lengthwise direction thereof as an example, the present disclosure is not limited thereto. The driving voltages loaded onto the driving electrodes 21 may be controlled so that the liquid crystal layer 22 is equivalent to a plurality of strip micro prisms and/or strip micro lenses converging the light emitted from different positions of the flat display panel 11 in the widthwise direction thereof, or, equivalent to a plurality of strip micro prisms and/or strip micro lenses converging the light emitted from different positions of the flat display panel 11 in both the lengthwise direction and the widthwise direction thereof, which will not be described in detail herein.

Certainly, it should be understood that, the strip micro prisms and the strip micro lenses shown in FIGS. 7-9 only indicate that the function of the liquid crystal layer 22 is the same as that of the strip micro prisms or the strip micro lenses, i.e., the liquid crystal layer 22 being “equivalent” to the strip micro prisms or the strip micro lenses does not mean that the liquid crystal layer 22 actually has such a structure, and also does not mean that the liquid crystal layer 22 is formed as such a structure.

Certainly, as shown in FIGS. 7-9, when the driving voltages loaded onto the driving electrodes 21 are changed, the liquid crystal layer 22 is equivalent to a different state of strip micro prisms or strip micro lenses, thus the liquid crystal layer 2 can converge the light to a different position.

Obviously, the liquid crystal layer 22 is equivalent to the strip micro prisms or the strip micro lenses described above under driving of the driving electrodes 22, thus the dimensions of the strip micro prisms or the strip micro lenses are dependent of the dimensions, the number etc. of the driving electrodes 21. Generally, each strip micro prism or strip micro lens is formed by a combined action of a number of driving electrodes 21 (certainly, the driving voltages loaded onto the driving electrodes 21 may be different from each other), and each strip micro prism or strip micro lens may correspond to several to tens columns of pixels.

In an embodiment, the driving electrodes 21 are electrode strips, and the lengthwise direction of each electrode strip is perpendicular to the lengthwise direction of the flat display panel 11.

That is to say, as shown in FIGS. 10-11, the driving electrodes 21 of the embodiment may be continuous or discontinuous electrode strips extending in the widthwise direction of the flat display panel 11 so that it is equivalent to the strip micro prisms or strip micro lenses.

In an embodiment, the driving electrodes 21 are electrode blocks (e.g., circular blocks, rectangle blocks and so on), the electrode blocks are arranged in an array.

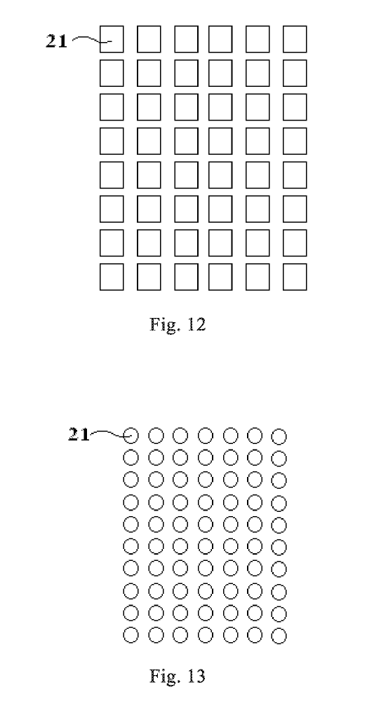

That is to say, as shown in FIGS. 12-13, the driving electrodes 21 of the embodiment may be electrode blocks arranged in an array, in this case, by loading changeable driving voltages onto the driving electrodes, the refraction effect can be controlled more flexibly (e.g., can achieve converging of light emitted from different positions of the flat display panel in both the lengthwise direction and the widthwise direction).

The embodiment further provides a driving method of the display apparatus described above, and the driving method comprises steps of:

S101, driving the flat display panel 11 to perform displaying; and

S102, loading a driving voltage onto each driving electrode 21 of the liquid crystal lens 2 so that the liquid crystal layer 22 of the liquid crystal lens 2 refracts (converges) a light (e.g., the light emitted in a direction perpendicular to the light exiting surface) emitted from different positions of the flat display panel 11 along the lengthwise direction (i.e., the first direction) thereof to a single position.

That is to say, when the flat display panel 11 of the display apparatus performs displaying, the driving voltages loaded onto the driving electrodes 21 of the liquid crystal lens 2 are adjusted so as to control the refraction effect of the liquid crystal lens 2, so that the light emitted from different positions of the flat display panel 11 along the lengthwise direction thereof is refracted to a single position (e.g., at which the person 9 is watching).

In an embodiment, the display apparatus further comprises an eye tracking device, and the driving method further comprises:

tracking positions of eyes by the eye tracking device before the step S102.

In this case, the step S1102 specifically comprises: loading the driving voltages onto the driving electrodes 21 of the liquid crystal lens 2 in accordance with the positions of eyes, so that the liquid crystal layer 22 of the liquid crystal lens 2 refracts the light emitted from different positions of the flat display panel 11 along the lengthwise direction thereof to the positions of eyes.

That is to say, when the display apparatus comprises the eye tracking device, the driving voltages loaded onto the driving electrodes 21 may be controlled in accordance with the positions of eyes determined by the eye tracking device, so that the light passing through the liquid crystal lens 2 is always converged to the positions of eyes (i.e., the converged positions are moving along with the eyes), a good display effect can be achieved.

It should be understood that, the above embodiments are merely exemplary embodiments for explaining principle of the present disclosure, but the present disclosure is not limited thereto. Various modifications and improvements may be made by those ordinary skilled in the art within the spirit and essence of the present disclosure, these modifications and improvements fall into the protection scope of the present disclosure.

1. A liquid crystal lens, comprising a liquid crystal layer and a plurality of driving electrodes, the liquid crystal layer corresponding to each driving electrode is configured to refract a light entered therein under driving of the driving electrode, each driving electrode is loaded with a driving voltage separately.

2. The liquid crystal lens of claim 1, further comprising:
a driving integrated chip with a plurality of channels, and each driving electrode is connected to one channel of the driving integrated chip through a lead wire.

3. A display apparatus, comprising:
a flat display panel configured to perform displaying;
the liquid crystal lens of claim 1, which is provided at a light exiting surface side of the flat display panel, and is configured to refract a light emitted from different positions of the flat display panel to a single position.

4. The display apparatus of claim 3, further comprising:
an eye tracking device configured to track positions of eyes,
the liquid crystal lens is configured to refract a light emitted from different positions of the flat display plane to the positions of eyes.

5. The display apparatus of claim 3, wherein,
the liquid crystal layer under driving of the driving electrodes is equivalent to a plurality of strip micro prisms and/or strip micro lenses.

6. The display apparatus of claim 3, wherein,
the liquid crystal lens is configured to refract a light emitted from different positions of the flat display panel along a first direction parallel to a side of the light exiting surface of the flat display panel to the single position.

7. The display apparatus of claim 6, wherein,
the flat display panel has a first dimension in the first direction, a second dimension in a second direction perpendicular to the first direction, the first dimension is equal to or larger than the second dimension,
wherein the second direction is in a plane where the light exiting surface of the flat display panel is located.

8. The display apparatus of claim 6, wherein,
the driving electrodes are electrode strips, and a lengthwise direction of each electrode strip is perpendicular to the first direction.

9. The display apparatus of claim 3, wherein,
the driving electrodes are electrode blocks, and the electrode blocks are arranged in an array.

10. The display apparatus of claim 3, wherein,
the liquid crystal lens is configured to refract a light emitted in a direction perpendicular to the light exiting surface from different positions of the flat display panel to the single position.

11. A driving method of the display apparatus of claim 3, the driving method comprising steps of:
driving the flat display panel to perform displaying;
loading a driving voltage onto each driving electrode of the liquid crystal lens so that the liquid crystal layer of the liquid crystal lens refracts a light emitted from different positions of the flat display panel to a single position.

12. The driving method of claim 11, wherein the display apparatus further comprises an eye tracking device, and the driving method further comprises:
tracking positions of eyes by the eye tracking device before loading the driving voltages onto the driving electrodes of the liquid crystal lens,
the step of loading the driving voltages onto the driving electrodes of the liquid crystal lens so that the liquid crystal layer of the liquid crystal lens refracts the light emitted from different positions of the flat display panel to the single position comprises: loading the driving voltages onto the driving electrodes of the liquid crystal lens in accordance with the positions of eyes, so that the liquid crystal layer of the liquid crystal lens refracts the light emitted from different positions of the flat display panel to the positions of eyes.
